(19) United States
(12) Patent Application Publication
(10) Pub. No.: US 2026/0119620 A1
(43) Pub. Date: Apr. 30, 2026

(54) DRM-BASED CONTENT ENCRYPTION/DECRYPTION SYSTEMS AND ENCRYPTION/DECRYPTION METHODS

(71) Applicant: Korea Electronics Technology Institute, Seongnam-si (KR)

(72) Inventors: Woo Chool PARK, Incheon (KR); Jun Hwan JANG, Paju-si (KR); Min Su CHOI, Seoul (KR); Jun Suk LEE, Seoul (KR); Bon Jae KOO, Suwon-si (KR)

(73) Assignee: Korea Electronics Technology Institute, Seongnam-si (KR)

(21) Appl. No.: 19/003,305

(22) Filed: Dec. 27, 2024

(30) Foreign Application Priority Data
Dec. 27, 2023 (KR) 10-2023-0192299

(51) Int. Cl. G06F 21/12; G06F 21/10; G06F 21/60

(52) U.S. Cl. CPC G06F 21/125; G06F 21/1066; G06F 21/602

(57) ABSTRACT

The present disclosure relates to methods and systems based on digital rights management (DRM), and more particularly to DRM-based encryption/decryption methods and encryption/decryption systems that can encrypt/decrypt content using metadata. The DRM-based content encryption system of the present disclosure may include a content provider that encrypts content to be encrypted based on encryption information received from a DRM server to generate encrypted content, a DRM server that provides said encryption information to the content provider based on a request from the content provider, a decryption server that provides decryption information corresponding to the encryption information to the user terminal based on a request from the user terminal, and the user terminal that decrypts the encrypted content based on the decryption information received from the DRM server to generate decrypted content.

### CROSS REFERENCE TO RELATED APPLICATION

The present application claims priority to a Korean Patent Application No. 10-2023-0192299, filed on Dec. 27, 2023, in the Korean Intellectual Property Office, the entire contents of which are incorporated herein for all purposes by reference.

### TECHNICAL FIELD

The present disclosure relates to a system and method for encrypting/decrypting content based on digital rights management (DRM), and more particularly to a DRM-based encryption/decryption system that can encrypt/decrypt content using metadata and a method for encrypting/decrypting such content.

### BACKGROUND

In recent years, the advancement of digital technology due to the spread of the Internet and the development of telecommunications has led to the problem of piracy, as digital content with the same quality as the original can be copied infinitely, and it is easy to reuse, process, and distribute, and can be transmitted anywhere in the world. One of the technologies used to prevent such harm and protect content from piracy is digital rights management (DRM). DRM refers to technologies and methods related to copyright protection of digital content, which are used by authors or distributors who create digital media or content to control and protect the use of that content. In other words, content is encrypted and decrypted with a content key, and DRM is applied to the content to restrict the use of the content. DRM systems can enable the free sharing of digital content between devices within the same domain. A domain is a network consisting of PCs, PDAs, video players, DVD players, etc. that can play content, such as a home network, private network, etc.

As the demand for 3D-based content has increased in recent years, 3D content sharing has also become more popular. Therefore, it is necessary for 3D content to be protected by DRM to ensure fair use of the content and prevent piracy.

### SUMMARY

The present disclosure provides a method and system for encrypting/decrypting any content, including 3D content, based on DRM. More specifically, it is to provide a method and a system for encrypting/decrypting DRM-based content using metadata.

According to the encryption/decryption system of the present disclosure, it may include a content provider that encrypts content to be encrypted based on encryption information received from a DRM server to generate encrypted content, a DRM server that provides said encryption information to the content provider based on a request from the content provider, a decryption server that provides decryption information corresponding to the encryption information to a user terminal based on a request from the user terminal, and a user terminal that decrypts the encrypted content based on decryption information received from the DRM server to generate decrypted content.

Other objects and advantages of the present disclosure will be understood from the following description and will become apparent from the embodiments of the present disclosure. It will also be readily apparent that the objects and advantages of the present disclosure may be realized by the means and combinations of means disclosed in the patent claims.

### Solution to the Challenge

A DRM-based content encryption system according to one aspect of the present disclosure includes: a content provider configured to generate encrypted content by encrypting content to be encrypted based on encryption information received from a DRM server; a DRM server configured to provide the encryption information to the content provider based on a request from the content provider and provides decryption information corresponding to the encryption information to a user terminal based on a request from the user terminal; and a user terminal configured to generate decrypted content by decrypting the encrypted content based on the decryption information received from the DRM server.

In a DRM-based content encryption system according to the present disclosure, the content to be encrypted may be 3D content.

In a DRM-based content encryption system according to the present disclosure, the encryption information may include a system identifier, a key identifier, and an encryption key. In this case, the system identifier, the key identifier may be represented by a universally unique identifier (UUID).

In a DRM-based content encryption system according to the present disclosure, the encryption information may be metadata received from a DRM server.

In a DRM-based content encryption system according to the present disclosure, the encrypted content may include said metadata.

In a DRM-based content encryption system according to the present disclosure, the encryption step may perform encryption for each of the elements comprising the 3D content. Each of said elements may comprise at least one of a Vertex, a Texture, an Animation, a Lighting, or a Material.

In a DRM-based content encryption system according to the present disclosure,, based on the applicability of one or more DRM to the encryption, said metadata may include metadata regarding all applicable DRM. Based on the applicability of one or more DRM to the encryption, the encryption key for encrypting said content may be the same.

In a DRM-based content encryption system according to the present disclosure, the encrypted content may include an encryption header block. The encryption header block may include at least one of a Type, a Key Index, Flags, or a Size, wherein the Type specifies an element corresponding to the encrypted content, the Key Index is information of a key used to encrypt the content, the Flags specifies a flag value used to encrypt the content, and the Size specifies a length of the entire data including the current data block.

In a DRM-based content encryption system according to the present disclosure, the encrypted content may comprise unauthenticated data, wherein the unauthenticated data may be rendered based on a failure of DRM authentication.

A method of encrypting DRM-based content, in accordance with other aspects of the present disclosure, may include a receiving step of receiving content to be encrypted, encryption information, and an encrypting step of encrypting the content to be encrypted based on the encryption information.

In the method of encrypting DRM-based content according to the present disclosure, the content to be encrypted may be 3D content.

In the method of encrypting DRM-based content according to the present disclosure, the encryption information may include a system identifier, a key identifier, and an encryption key. In this case, the system identifier, the key identifier may be represented by a universally unique identifier (UUID).

In the method of encrypting DRM-based content according to the present disclosure, the encryption information may be metadata received from a DRM server.

In the method of encrypting DRM-based content according to the present disclosure, said encrypted content may include said metadata.

In the method of encrypting DRM-based content according to the present disclosure, the encryption step may be performed for each element of the 3D content. Each of said elements may comprise at least one of a Vertex, a Texture, an Animation, a Lighting, or a Material.

In the method of encrypting DRM-based content according to the present disclosure, based on the applicability of one or more DRM to the encryption, said metadata may include metadata regarding all applicable DRM. Based on the applicability of one or more DRM to the encryption, the encryption key for encrypting said content may be the same.

In the method of encrypting DRM-based content according to the present disclosure, the encrypted content may include an encryption header block. The encryption header block may include at least one of a Type, a Key Index, Flags, or a Size, wherein the Type specifies an element corresponding to the encrypted content, the Key Index is information of a key used to encrypt the content, the Flags specifies a flag value used to encrypt the content, and the Size specifies a length of the entire data including the current data block.

In the method of encrypting DRM-based content according to the present disclosure, the encrypted content may comprise unauthenticated data, wherein the unauthenticated data may be rendered based on a failure of DRM authentication.

A method for decrypting DRM-based content, according to another aspect of the present disclosure, may include a receiving step of receiving encrypted content, decryption information, and a decrypting step of decrypting the encrypted content based on the decryption information.

In the method for decrypting DRM-based content according to the present disclosure, the encrypted content may be 3D content.

In the method for decrypting DRM-based content according to the present disclosure, the decryption information may include a system identifier, a key identifier, and a decryption key. In this case, the system identifier, the key identifier may be represented by a universally unique identifier (UUID).

In the method for decrypting DRM-based content according to the present disclosure, the decryption information may be metadata received from a DRM server.

In the method for decrypting DRM-based content according to the present disclosure, the encrypted content may include the metadata.

In the method for decrypting DRM-based content according to the present disclosure, the decryption step may be performed for each of the elements of the 3D content. Each of said elements may comprise at least one of a Vertex, a Texture, an Animation, a Lighting, or a Material.

In the method for decrypting DRM-based content according to the present disclosure, based on one or more DRM being applicable to the decryption, said metadata may comprise metadata regarding all applicable DRM. In this case, based on the applicability of one or more DRM to the decryption, the decryption keys for decrypting the content may be the same.

In the method for decrypting DRM-based content according to the present disclosure, the encrypted content may include an encryption header block. The encryption header block may include at least one of Type, Key Index, Flags, or Size, wherein the Type specifies an element corresponding to the encrypted content, the Key Index is information of a key used to encrypt the content, the Flags specifies a flag value used to encrypt the content, and the Size specifies a length of the entire data including the current data block.

In the method for decrypting DRM-based content according to the present disclosure, the encrypted content may comprise unauthenticated data, wherein the unauthenticated data may be rendered based on a failure of DRM authentication.

According to the DRM-based content encryption/decryption system and method of the present disclosure, by encrypting/decrypting content using metadata, security can be enhanced compared to prior art, and encryption/decryption can be performed with lightweight data and is efficient.

In addition, the DRM-based content encryption/decryption system and method of the present disclosure can provide users with greater freedom in content presentation while protecting the copyright holder's work, and can be simpler and less system resource consuming than prior art.

The various beneficial advantages and effects of the present disclosure are not limited to the foregoing, and will be more readily understood in the course of describing specific embodiments of the present disclosure.

### BRIEF DESCRIPTION OF THE DRAWINGS

The following drawings, which accompany this specification, illustrate preferred embodiments of the present disclosure and serve to further illustrate the technical ideas of the invention in conjunction with the detailed description of the invention that follows, and the invention is not to be construed as limited to what is shown in such drawings.

FIG. 1 is a block diagram of a DRM-based content encryption/decryption system according to one embodiment of the present disclosure.

FIG. 2 is a flowchart of the DRM-based content encryption method performed on the content provider side of the system in FIG. 1.

FIG. 3 is a block diagram illustrating the presence of one or more DRM services, according to one embodiment of the present disclosure.

FIG. 4 is a block diagram showing an example of different formats depending on the format of the file type.

FIG. 5 shows a coded representation of the process of inserting metadata.

FIG. 6 shows a diagram of the encryption header block that is added before the encrypted content.

FIG. 7 shows the format of the dummy data used for unauthenticated data.

FIG. 8 is a flowchart of the DRM-based content decryption method performed on the user terminal side of the system of FIG. 1.

### DETAILED DESCRIPTION

The present disclosure is subject to various modifications and may have many different embodiments, certain embodiments are illustrated and described in detail in the drawings. However, this is not intended to limit the present disclosure to any particular embodiment, and is to be understood to include all modifications, equivalents, or substitutions that fall within the scope of the ideas and techniques of the present disclosure. For a detailed description of the exemplary embodiments described hereinafter, reference is made to the accompanying drawings, which illustrate certain embodiments by way of example. These embodiments are described in sufficient detail to enable those skilled in the art to practice the embodiments. It is to be understood that the various embodiments are different but need not be mutually exclusive. For example, certain shapes, structures, and features described herein may be implemented in other embodiments without departing from the spirit and scope of this disclosure with respect to any one embodiment. It is also to be understood that the location or arrangement of individual components within each of the disclosed embodiments may be changed without departing from the spirit and scope of the embodiment. Accordingly, the detailed description that follows is not intended to be limiting, and the scope of the exemplary embodiments is limited only by the appended claims, which, when properly described, have all the force and effect of the claims as claimed therein.

The components shown in the embodiments of the present disclosure are shown independently to illustrate different characteristic functions and are not intended to imply that each component comprises a separate unit of hardware or software, i.e., each component is listed and included as a separate component for ease of description, and at least two of each component may be combined to form a single component, or a single component may be divided into multiple components to perform a function, and such combined and separate embodiments of each component are included within the scope of the present disclosure without departing from the spirit of the present disclosure.

The terms used in this disclosure are used to designate particular embodiments and are not intended to limit the disclosure. Expressions in the singular include the plural unless the context clearly indicates otherwise. In this disclosure, the terms “including” or “having” and the like are intended to designate the presence of the features, numbers, steps, operations, components, parts, or combinations thereof described, and are not to be understood as precluding the possibility of the presence or addition of one or more other features, numbers, steps, operations, components, parts, or combinations thereof. In other words, a description in this disclosure that “includes” a particular configuration is not intended to exclude configurations other than that configuration, and additional configurations may be included in the practice of this disclosure or within the scope of the technical ideas of this disclosure.

Unless otherwise defined, all terms used herein, including technical or scientific terms, shall have the same meaning as commonly understood by one of ordinary skill in the relevant art. Such terms, as defined in commonly used dictionaries, shall be construed to have meanings consistent with their contextual meaning in the relevant art and shall not be construed to have an idealized or unduly formal meaning unless expressly defined herein.

Hereinafter, preferred embodiments of the present disclosure will be described in detail with reference to the accompanying drawings. In describing the embodiments of this disclosure, where it is determined that a detailed description of the relevant disclosed components or features would obscure the essence of the disclosure, such detailed description is omitted, and identical components in the drawings are designated by the same reference numerals and duplicate descriptions of the same component are omitted.

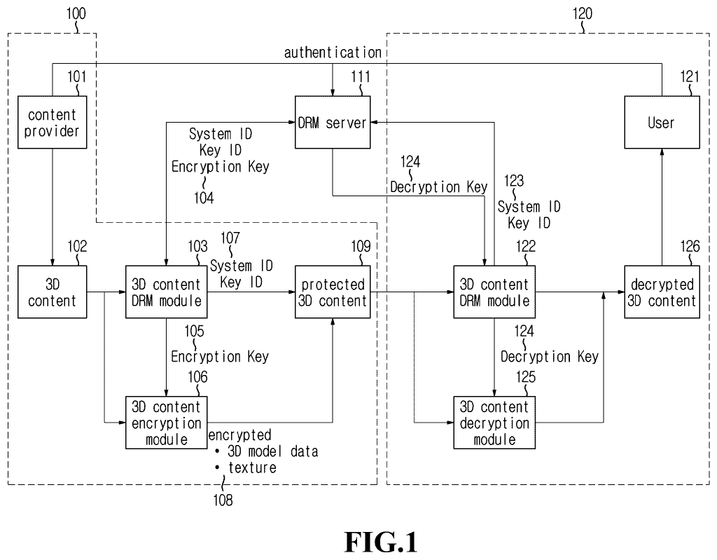

FIG. 1 is a simplified block diagram of a DRM-based content encryption/decryption system according to one embodiment of the present disclosure.

As shown in FIG. 1, a DRM-based content encryption/decryption system may comprise a content provider 101, a DRM server 111, and a user 121. Considering first the DRM-based content encryption side 100, the content provider 101 may first provide the 3D content 102 to be shared as input to the 3D content DRM module 103 and the 3D content encryption module 106. When the 3D content DRM module 103 receives the 3D content 102 as input from the content provider 101, the 3D content DRM module 103 may receive encryption information 104 for protecting the content through DRM service authorization from the DRM server 111. The encryption information 104 may include a system identifier (System ID), a key identifier (Key ID), and an encryption key (Encryption Key). The system identifier and the key identifier included in the encryption information may be represented as a universally unique identifier (UUID) value. The 3D content DRM module 103 may embed metadata necessary for decrypting the DRM-applied 3D content into the protected 3D content 109. The 3D content encryption module 106 may perform encryption for each of the elements 108 comprising the 3D content using the 3D content 102 and the encryption key 105 received from the 3D content DRM module 103 as input. Each of the elements 108 of the 3D content may include at least one of Vertices, Texture, Animations, Lighting, or Materials.

After the above encryption process, the protected 3D content 109 may be generated by inputting the encrypted 3D content via the 3D content encryption module 106 and the system identifier and key identifier 107 from the 3D content DRM module 103. The protected 3D content 109 may be transmitted to the user 121 terminal and restored to a usable form through a decryption process.

Finally, turning to the DRM-based content decryption side 120, the user 121 may extract DRM-related information from the embedded metadata within the protected 3D content 109 and perform DRM service authentication. In this case, the DRM-related information to be extracted may be a system identifier and a key identifier 123. The system identifier and key identifier 123 may be checked for support, and if not supported, the decryption and restoration of the protected 3D content 109 may fail. If the DRM server 111 successfully authenticates the service with the system identifier and key identifier 123 provided by the 3D content DRM module 122, the 3D content DRM module 122 may receive a decryption key 124 from the DRM server 111. Upon successful service authentication, the 3D content decryption module 125 may receive input from the protected 3D content 112 and the decryption key 124 from the 3D content DRM module 122 and decrypt the 3D content into a usable form to generate the decrypted 3D content 126. The decrypted 3D content 126 generated through the above decryption process can be rendered and displayed on the user terminal.

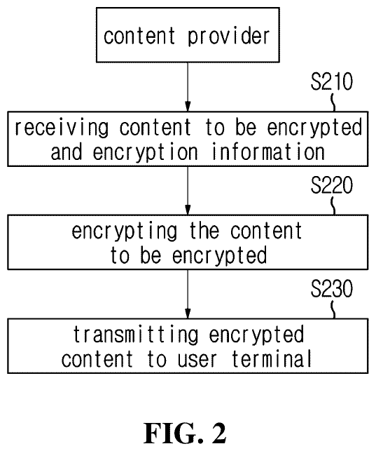

FIG. 2 is a simplified flowchart of the DRM-based content encryption method performed on the content provider side of the system in FIG. 1.

Referring to FIG. 2, the content provider side in the DRM-based content encryption system may first receive content to be encrypted and encryption information (S210). The content to be encrypted may be produced by the content provider side, or may be obtained in advance. The encryption information may be received from a DRM server. The content to be encrypted may be 3D content, and the encryption information may include a system identifier, a key identifier, and an encryption key. In this case, the system identifier and key identifier may be represented by a universally unique identifier (UUID) value. Then, based on said encryption information, an encryption step of encrypting the content to be encrypted may be performed (S220). The encryption step may perform encryption for each of the elements comprising the 3D content. Each of the elements of the 3D content may comprise at least one of a Vertex, a Texture, an Animation, a Lighting, or a Material. Finally, the content provider may transmit the encrypted content to the user terminal via the above encryption step (S230).

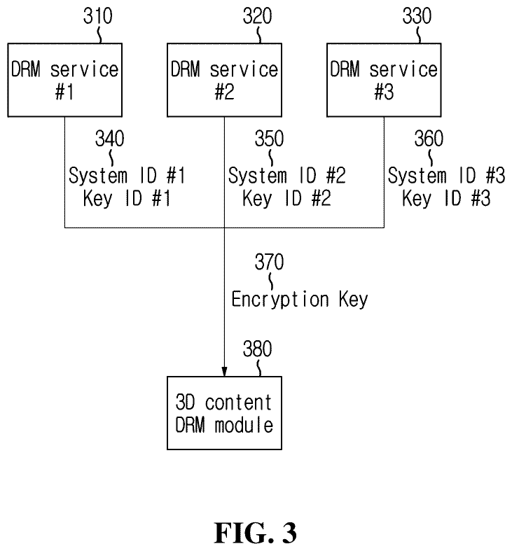

FIG. 3 is a simplified block diagram illustrating the presence of one or more DRM services, according to one embodiment of the present disclosure.

Referring to FIG. 3, one or more DRM may be applied to a piece of content in a DRM-based content encryption system. For example, it may be possible for DRM service #1 (310), DRM service #2 (320), and DRM service #3 (330) to be applied to a piece of content during encryption, as illustrated in FIG. 3. Based on the applicability of more than one DRM to the encryption, the metadata may include metadata regarding all applicable DRM. The metadata regarding the DRM may include a System ID #1 and a key identifier (Key ID #1) 340, a System ID #2 and a key identifier (Key ID #2) 350, and a System ID #3 and a key identifier (Key ID #3) 360, for each DRM service. Based on the applicability of one or more DRMs to the encryption, the Encryption Key (370) for encrypting the content may use the same value. Eventually, if more than one DRM is applied, each of the System Identifier and Key Identifier 340, 350, 360 and Encryption Key 370 may be provided to the 3D content DRM module 380.

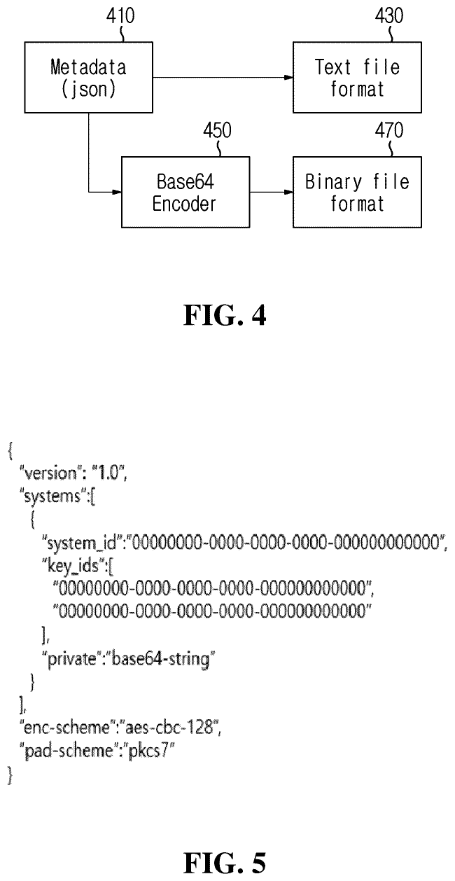

FIG. 4 is a block diagram showing an example that when metadata is inserted the metadata is stored in different formats depending on the format of the file format.

Commonly used 3D content file formats allow for the insertion of additional data in addition to object data. The 3D content file format may include at least one of gltf, fbx, obj, stl, and glb. The gltf may be a lightweight 3D file format, which may be suitable for web-based 3D graphics. The fox is a binary file format for exchanging Model, Animation, Texture, Lighting information, and the like between various 3D applications. The obj is a simple, text-based 3D model format. The stl is a format for storing triangular mesh data used in 3D printing and computer-aided design (CAD). The glb is a binary version of gltf, which contains all resources in one file. Information required for applying DRM and information about encryption method/target, etc. may be stored together in the file as metadata.

Referring to FIG. 4, the metadata may be inserted in json format (JavaScript Object Notation, 410). The json is a lightweight data format used to exchange data. The json is organized in a format that is easy for humans to read and write, and easy for machines to analyze and generate. It is often used to transfer data between web applications and servers, or to create configuration files. Metadata can be stored in different formats depending on the format of the file format above. For example, a text file format (gltf, obj, etc. 430) may be stored in json format. As another example, a binary file format (glb, fbx, etc., 470) may be stored by base 64 encoding the json string with a base 64 encoder 450.

FIG. 5 is a coded representation of the process of inserting metadata.

As illustrated in FIG. 4 above, more than one DRM may be applicable to a piece of content within a DRM-based content encryption system. In this case, multiple DRMs should be included in the system to support multiple DRMs. Also, to support multiple keys, a list of key ids that can be supported by the DRM system may be stored in the key_ids item.

Referring to FIG. 5, system_id and key_id can be represented as Universally Unique Identifier (UUID) values. In coding, as follows,

```
System_id“:“00000000-0000-0000-0000-000000000000“,
  ″key_ids″: [
    “00000000-0000-0000-0000-000000000000”,
    “00000000-0000-0000-0000-000000000000”
    ]
```

The UUID is a universally unique identifier, which is a 128-bit number, typically consisting of 32 hexadecimal digits and four hyphens. Private can be stored as a base64 string with additional data required by each DRM system. In coding, as follows, “private”: “base64-string”

Also, enc-scheme can specify the encryption algorithm used by this file. Finally, pad-scheme can specify the padding algorithm when using block ciphers. In coding, as follows,
“enc-scheme”: “aes-cbc-128”,
“pad-scheme”: “pkcs7”

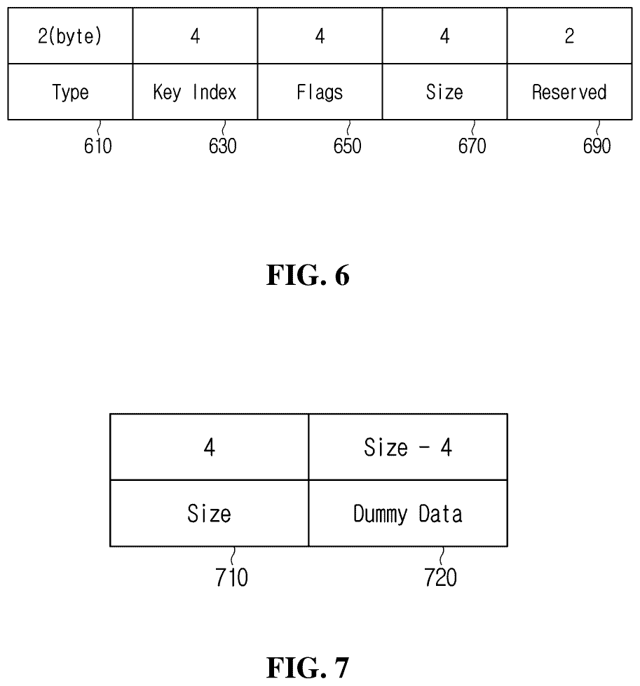

FIG. 6 is a diagram of the encryption header block that is added before the encrypted content.

There can be two ways of using 3D content data: directly embedding the data within the file and referencing an external file. When performing the above encryption process, the entire content data to be encrypted may be encrypted. In the above encryption process, an encryption header block may be additionally stored before the encrypted data, i.e., the encrypted content may include an encryption header block. In this case, the size of the data block may be 16 bytes.

Referring to FIG. 6, the encryption header block may include at least one of Type (610), Key Index (630), Flags (650), or Size (670). The Type 610 may specify the type of data corresponding to the encrypted content (e.g., element, e.g., Vertex, Texture, Animation, Lighting, or Material), the Key Index 630 may be the information of the key used to encrypt the content, the Flags 650 may specify the flag value used to encrypt the content, and the Size 670 may specify the length of the entire data including the current data block. Finally, Reserved (2 bytes, 690) may be fixed to zero to keep the size of the data block at 16 bytes.

FIG. 7 shows the format of the dummy data used for outputting the unauthenticated data. If it wants to output the unauthenticated data rather than error handling in the event of DRM authentication failure, it may be possible for the encrypted data to contain data for an unencrypted dummy. In this case, the flags value in the encryption header block can be set to include 0×01. If the 3D content data is embedded directly within the file, the dummy data may be added after the encrypted data. When the dummy data is added, the size value of the encryption header block may not be changed.

Referring to FIG. 7, the dummy data may be formatted as Size 710, and Dummy Data 720. If the 3D content data references an external file, it can be saved as a separate file by appending a “.dummy” file after the filename including the extension.

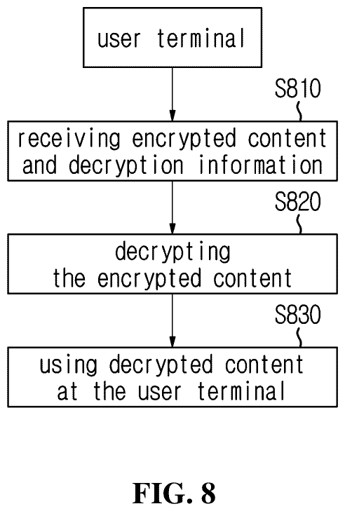

FIG. 8 is a flowchart of the DRM-based content decryption method performed on the user terminal side of the system of FIG. 1.

Referring to FIG. 8, a user terminal side in a DRM-based content decryption system may first receive encrypted content and decryption information (S810). The encrypted content may be received from a content provider. The decryption information may be received from a DRM server. The encrypted content may be 3D content, and the decryption information may include a system identifier, a key identifier, and a decryption key. Then, a decryption step of decrypting the encrypted content based on said decryption information may be performed (S820). The decryption step may be performed for each of the elements comprising the 3D content. Each of the elements of the 3D content may include at least one of a Vertex, a Texture, an Animation, a Lighting, or a Material. Finally, the decrypted content from the above decryption step can be rendered on the user terminal (S830).

The embodiments described above include examples of various forms. While it is not possible to describe all possible combinations to represent the various forms, one of ordinary skills in the art will recognize that other combinations are possible. Accordingly, this disclosure is intended to encompass all other substitutions, modifications, and changes that fall within the scope of the following patent claims.

The foregoing description of the present disclosure is for illustrative purposes only, and those having ordinary knowledge in the technical field to which the present disclosure belongs will understand that it can be readily adapted to other specific forms without altering the technical idea or essential features of the present disclosure. The embodiments described above are therefore to be understood in all respects as exemplary and not limiting. For example, each component described in a single form may be implemented in a distributed manner, and similarly, successive components described as distributed may be implemented in a combined form. While the present disclosure has been described above with reference to specific details, such as specific components, and with reference to limited embodiments and drawings, these are provided for the purpose of providing a more general understanding of the disclosure, and are not intended to limit the disclosure to these embodiments, and those having ordinary skill in the art will be able to make various modifications and variations from these descriptions.

Accordingly, the ideas of the present disclosure are not to be limited to the foregoing embodiments, and the following patent claims and all equivalents or equivalent modifications thereof are intended to fall within the scope of the ideas of the present disclosure.

What is claimed is:

1. DRM-based content encryption system comprises,
a content provider configured to generate encrypted content by encrypting content to be encrypted based on encryption information received from a DRM server;
a DRM server configured to provide the encryption information to the content provider based on a request from the content provider and provides decryption information corresponding to the encryption information to a user terminal based on a request from the user terminal; and
a user terminal configured to generate decrypted content by decrypting the encrypted content based on the decryption information received from the DRM server.

2. A method of encrypting DRM-based content comprises,
receiving content to be encrypted and encryption information; and
encrypting the content to be encrypted based on the encryption information.

3. The method of claim 2,
wherein the content to be encrypted is 3D content.

4. The method of claim 2,
wherein the encryption information comprises at least one of a System ID, a Key ID, or an Encryption Key.

5. The method of claim 4,
wherein the encryption information is metadata received from the DRM server.

6. The method of claim 2,
wherein the encrypted content includes metadata.

7. The method of claim 2,
wherein the encrypting performs encryption per each elements of 3D content.

8. The method of claim 7,
wherein the elements of 3D content comprises at least one of a vertex, a texture, an animation, a lighting, or a material.

9. The method of claim 2,
wherein based on applicability of one or more DRMs to the encryption. the metadata comprises metadata regarding all applicable DRM.

10. The method of claim 2,
wherein the encrypted content comprises an encryption header block comprising at least one of Type, Key Index, Flags, or Size, and
wherein the Type specifies an element corresponding to the encrypted content, the Key Index is information of a key used to encrypt the content, the Flags specifies a flag value used to encrypt the content, and the Size specifies a length of the entire data including current data block.

11. The method of claim 2,
wherein the encrypted content comprises unauthenticated data, the unauthenticated data being rendered based on a failure of DRM authentication.

12. A method of decrypting DRM-based content comprises,
receiving encrypted content and decryption information; and
decrypting the encrypted content based on the decryption information.
